(19) United States
(12) Patent Application Publication
(10) Pub. No.: US 2008/0140468 A1
(43) Pub. Date: Jun. 12, 2008

(54) COMPLEX EXPONENTIAL SMOOTHING FOR IDENTIFYING PATTERNS IN BUSINESS DATA

(75) Inventors: Mark S. Ramsey, Kihei, HI (US); David A. Selby, Nr Fareham (GB); Stephen J. Todd, Hants (GB)

Correspondence Address: HOFFMAN, WARNICK & D'ALESSANDRO LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 11/567,329

(22) Filed: Dec. 6, 2006

(51) Int. Cl. G06Q 10/00

(52) U.S. Cl. 705/7

(57) ABSTRACT

A system, method and program product for detecting patterns. A system is provided that includes: a monitor for capturing event values from an entity; a running value calculation system that calculates a new running value based on a previous running value using complex exponential smoothing, wherein both the new running value and previous running value are complex numbers; and an analysis system for recognizing patterns by analyzing the new running value.

### FIELD OF THE INVENTION

The invention relates generally to pattern detection, and more particularly to a system and method of using exponential smoothing to identify patterns in business data.

### BACKGROUND OF THE INVENTION

It is often desirable to understand and detect regular patterns in business data. For example, it is typical for automatic teller machines (ATMs) to be subject to weekend bursts of usage. In such a case, understanding the patterns will allow the financial institution to stock the machines with the proper amount of cash and ensure that no fraudulent activity is occurring. For some applications, it is just necessary to recognize the basic pattern. For other applications, such as fraud detection, it is necessary to have continuous detection to find any deviation of the pattern from the normal behavior.

There are various accepted techniques that are used for pattern detection, including auto-correlation and Fourier analysis. Unfortunately, such techniques have various disadvantages, particularly where the detection needs to be carried out for many entities on a “running” basis. Disadvantages include that fact that these techniques require a significant amount of historical data to be accessed on a regular basis as part of a running calculation. Data access is expensive and may slow down calculations. Furthermore, Fourier analysis is very dependent on the width of the windows chosen, and therefore can yield spurious results that are side-effects of ill chosen windows, and good results can be masked. Also, Fourier analysis does not work well for wide ranging variations on potential pattern width. Moreover, such techniques are not easily modified for use on irregular event sampling.

Accordingly, a need exists for a pattern detection technique that can operate on a running basis and not be subject to the limitations described above.

### SUMMARY OF THE INVENTION

The present invention addresses the above-mentioned problems, as well as others, by providing a pattern detection system and method that uses complex exponential smoothing (also know as exponential spectral analysis) to identify patterns. The method has several advantages including the fact that monitors can be tuned to be sensitive to specific application meaningful repeat patterns (e.g., hour, day, and week); there is relatively little history data to access for each event on each entity; there is one complex number to save for each entity for each wavelength to be monitored; the technique is easily modified to irregular entity events (such as that found with credit card transactions and many other application areas); the sensitivity and bandwidth may be adjusted independently for each monitor; and monitors may be added, removed and reconfigured dynamically.

In a first aspect, the invention provides a system for detecting patterns, comprising: a monitor for capturing event values from an entity; a running value calculation system for calculating a new running value based on a previous running value using complex exponential smoothing, wherein both the new running value and previous running value are complex numbers; and an analysis system for recognizing patterns by analyzing the new running value.

In a second aspect, the invention provides a computer program product stored on a computer readable medium for detecting patterns, comprising: program code configured for capturing event values from an entity; program code configured for calculating a new running value based on a previous running value using complex exponential smoothing; and program code configured for recognizing patterns by analyzing at least one of a strength and a phase of the new running value.

In a third aspect, the invention provides a method of detecting patterns in business event data, comprising: selecting a wavelength and wavelength number; capturing an event value; calculating a new running value based on the event value, wavelength, wavelength number and a previous running value using complex exponential smoothing; and analyzing the new running value to determine an existence of a pattern.

In a fourth aspect, the invention provides a method for deploying pattern detection system, comprising: providing a computer infrastructure being operable to: capture event values from an entity; calculate a new running value based on a previous running value using complex exponential smoothing; and search for patterns by analyzing at least one of a strength and a phase of the new running value.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts pattern detection system in accordance with an embodiment of the present invention.

FIG. 2 depicts a flow diagram of a method of detecting a pattern in accordance with an embodiment of the present invention.

### DETAILED DESCRIPTION OF THE INVENTION

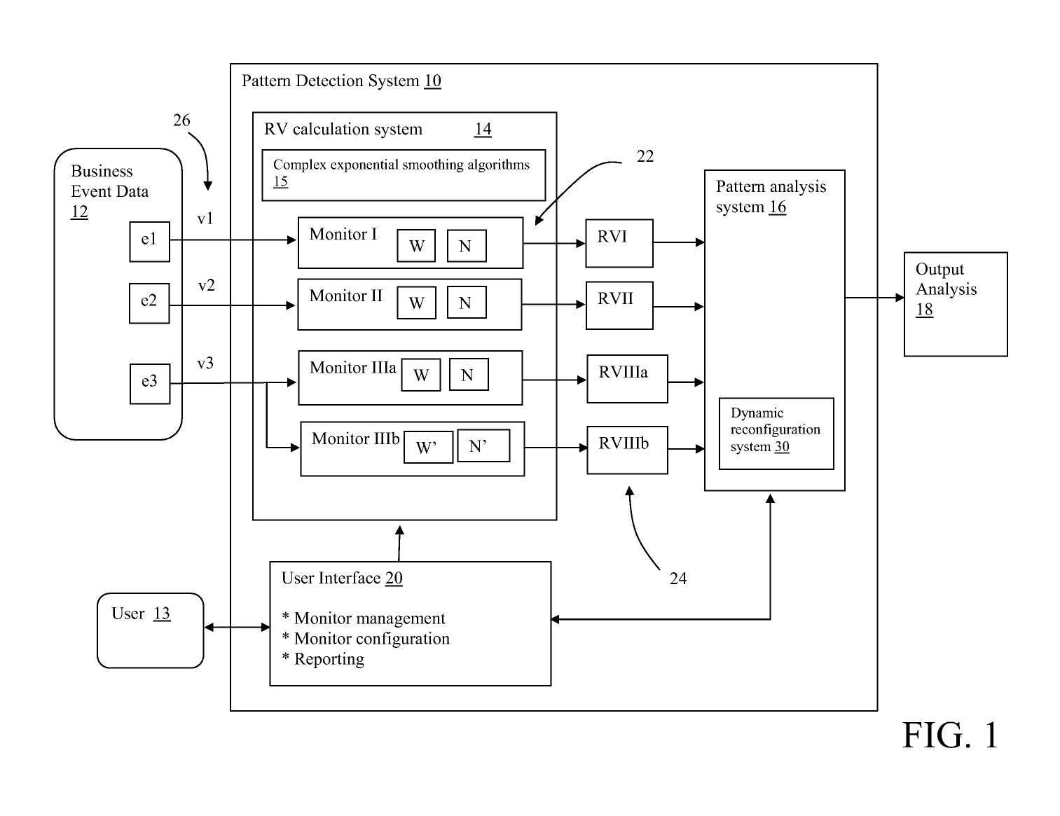

Referring now to drawings, FIG. 1 depicts a pattern detection system 10 that analyzes business event data 12 to detect and verify patterns. Illustrative types of business event data 12 include, but are not limited to: financial transactions (e.g., ATM activities, credit card usage, banking activities, etc.); network transactions (e.g., bandwidth usage, transfers, login activities, etc.); operational transactions (e.g., computer usage, human resource activities, workflow, production, etc.), etc. In the example shown in FIG. 1, business event data 12 is collected from three different entities e1, e2, and e3 that periodically generate event values 26, i.e., v1, v2 and v3. Entities may comprise any source, device, program, etc., that generates business event data 12, e.g., individual bank accounts, an ATM, a network node, etc. It is understood that the invention is not limited to any particular number or type of entities or business event data 12.

Business event data 12 may comprise event values 26 collected at regular time periods (e.g., daily batch processing of ATM transactions) or at irregular time periods (e.g., a user's credit card activity). Rather than store and access historical event data, pattern detection system 10 generates a new running value (RV) based on a previous running value each time a new event value 26 is inputted into the pattern detection system 10. Thus, very little information needs to be stored and accessed for each entity being monitored.

To achieve this, pattern detection system 10 includes a running value calculation system 14 that utilizes complex exponential smoothing algorithms 15 to calculate new running values (e.g., RVI, RVII, RVIIIa, RVIIIb) 24 each time a new event value (e.g., v1, v2, v3) 26 is inputted. Each running value 24 is a complex number that includes both a real and imaginary component. Running value calculation system 14 utilizes at least one monitor 22 for each entity (e) being monitored. Each monitor 22 computes new running values 24 based on a selected wavelength W and a damping factor K. The damping factor K is determined based on a selected wavelength number N in a manner described below.

A user interface 20 is provided to allow a user 13 to create, delete and modify monitors 22. In addition, user 13 is allowed to configure each monitor 22 by selecting a wavelength W, a wavelength number N, and whether data is collected at regular or irregular time periods. Further, user interface 20 may allow user 13 to select a type of output analysis 18 that is to be provided by a pattern analysis system 16.

Pattern analysis system 16 may be utilized to examine running values 24 and provide some type of analysis output 18, or dynamically reconfigure the monitors 22 via dynamic reconfiguration system 30. Illustrative types of analysis may include: pattern strength, pattern phase, anomalies in patterns, potential fraudulent activities, warnings, reports, etc. In one illustrative embodiment, pattern phase and strength may be compared to threshold values to determine the existence of a pattern. Obviously, the type of pattern analysis employed by pattern analysis system 16 will depend on the particular application and business needs. Accordingly, it is understood that the invention is not limited to any particular type of analysis.

In the case where events are monitored at regular cycle intervals (e.g., every day at 12:00 AM), a first complex exponential smoothing algorithm 15 is utilized. In the simplest case, it is assumed that just a single repeat pattern W is to be monitored, where W is the length of the repeat pattern in event cycles (e.g., wavelength=7). Note that W need not be an integer.

First, a complex number C, which is the principle W'th root of 1, is calculated as follows:

C=cos(2*pi/W)+i*sin(2*pi/W),

where i is the square root of −1. Thus, for example, if W were chosen as 7 days, then C would be 0.998+i*0.0157.

As noted above, a damping factor K is used. K may be chosen such that the half life of the exponential smoothing curve is N wavelengths. In most applications, N is typically chosen in the region of 2 to 3, since values less than 2 cannot reliably pick up a pattern and values larger 3 will give more precise sensitivity peaks for a monitored wavelength, but will be slower to react to pattern changes. K is computed as follows:

K=0.5**(1/(W*N))

These two factors K and C are combined into a single complex exponential factor KC,

KC=K*C

For each entity and monitored pattern W, a single running complex number RV 24 is maintained. When a new observation v arrives for the entity, a next value for RV is computed according the following equation:

RV=KC*RV+(1−K)*v

### Note that KC and (1—K) can be pre-computed to save time.

The absolute value of RV (abs(RV)) gives a measure of the strength of the pattern for the wavelength W. The complex “direction” of RV gives the phase of the pattern. For example, RV will be a pure positive real number on the ‘beat’ of the pattern, and pure positive imaginary number a quarter of the way to the next beat. Thus,

strength=abs(RV), and

phase=RV/abs(RV).

If event values 26 do not come at regular time intervals, i.e., in an asynchronous fashion, the computation is varied by utilizing the following complex exponential smoothing algorithm 15. Namely, whenever event value v arrives at a time interval T after the previous event (T may be an integer, but does not have to be), the following equation is utilized:

RV=KC**T*RV+(1−K**T)*v

Again, KC and 1—K may be pre-computed. Note also that if T is constrained to integer values, values for KC**T and 1−K**T may also be pre-computed and cached.

With conventional exponential smoothing used to compute running averages it is acceptable to have some ‘fuzziness’ about the values used for KC and KC**T, as the values being computed have only general statistical meaning and the fuzziness only leads to slight variations in the damping factor. However, for complex exponential smoothing such approximation is not appropriate as it would distort the wavelength detection.

The techniques describe above can be applied over multiple entities (e.g., e1, e2, e3), multiple wavelengths (e.g., W, W′), and multiple wavelength numbers (N) by, e.g., keeping arrays of running values RV[e, W, N]. An array of pre-computed values KC[W] and KC1 [W] (where KC1 [W]=1−K[W]) can also be maintained. The running computations are highly amenable to parallel implementation.

Note that there is complete application flexibility for the choice of wavelengths. In some applications where there are no pre-expectation of pattern lengths, they may be chosen at regular intervals (e.g., wavelengths may be arranged exponentially). Other applications may have very specific likely intervals, such as minute, hour, day, week, month, etc. The chosen wavelengths do not have to be the same for different entities.

The damping factor K, which corresponding to the sensitivity of the monitor, similarly does not have to be the same for each monitor. Accordingly, a smaller N will result in a more broadband monitor that will respond quickly but will not give a precise indication of the wavelength. A larger value of N, which provides a more narrowband monitor, will respond more slowly but be more targeted to a specific wavelength. For example, entity e3 is monitored by two monitors, monitor IIIa and IIIb, which may utilize different values for W and N.

Given the ability to readily add, remove or modify monitors 22, a tremendous amount of flexibility is available to pattern analysis system 16 in identifying and verifying patterns. For instance, user 13 could define a primary set of monitors for specific wavelengths, and then define a few extra monitors to fill in the in-between values. Then, by analyzing the results, preferred wavelengths and sensitivities can be zeroed in on for the entity. For example, a primary set of monitors could be implemented for wavelengths of day and week, and then a couple of extra fill-in monitors could be defined around those primary wavelengths. These fill-in monitors could be arranged in some arbitrary way (e.g., 2 days, 4 days, etc.); or exponentially (e.g., 7**(1/3) days [about 1.9 days] and 7**(2/3) days [about 3.7 days]).

It may be appropriate to have the fill-in monitors use smaller values of N, thus giving them a broader spectral range. If any unexpected fill-in signal is detected by these broadband monitors, it may then be necessary to revert to looking at fuller historical data to identify the new pattern more precisely. As noted earlier, such full history access is undesirable on a regular basis; however it is quite reasonable on a detection event basis.

Once a new pattern has been identified, pattern analysis system 16 may utilize a dynamic reconfiguration system 30 to dynamically reconfigure the monitors 22 to take into account this new pattern. For example, if a 3 day pattern was noticed, the monitors could be modified to provide primary pattern monitors at 1 day, 3 days and 7 days, and two fill-in monitors for sqrt(3) days and 3*sqrt(7/3) days. This type of complementary work may alternatively be performed manually by user 13 via user interface 20.

In general, pattern detection system 10 may be implemented using any type of computing device, and may be implemented as part of a client and/or a server. Such a computing device generally includes a processor, input/output (I/O), memory, and a bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus provides a communication link between each of the components in the computing system and likewise may comprise any known type of transmission link, including electrical, optical, wireless, etc. Additional components, such as cache memory, communication systems, system software, etc., may be incorporated into the computing system.

Access to pattern detection system may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system comprising pattern detection system could be created, maintained and/or deployed by a service provider that offers the functions described herein for customers. That is, a service provider could offer to provide pattern detection as described above.

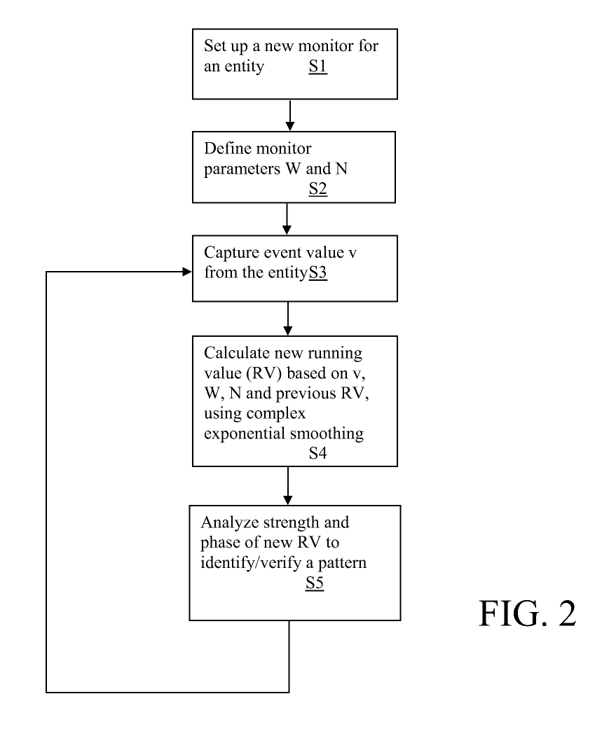

FIG. 2 depicts a flow diagram showing a method of implementing the pattern detection system 10 described above. At step S1, a new monitor is set up for an entity and at step S2 monitor parameters W and N are defined. At step S3, an event value is captured from the entity. Next, at step S4, a new running value is calculated using complex exponential smoothing based on the event value, W, N and a previous event value. At step S5, the new running value is analyzed to determine the existence of a pattern. For instance, the strength (e.g., abs(RV)) and phase (e.g., RV/abs(RV)) could be compared to predetermined threshold values that indicate the existence of a pattern. Steps S3-S6 are then repeated.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for detecting patterns, comprising:
a monitor for capturing event values from an entity;
a running value calculation system for calculating a new running value based on a previous running value using complex exponential smoothing, wherein both the new running value and previous running value are complex numbers; and
an analysis system for recognizing patterns by analyzing the new running value.

2. The system of claim 1, wherein event values comprise business event data selected from the group consisting of: financial transactions, network transaction, and operational transactions.

3. The system of claim 1, wherein for event values captured at regular time periods, a new running value RV_{N} for a captured event value v is calculated using:
RV_{N}=KC*RV_{P}+(1−K)*v,
where:
K=0.5**(1/(W*N)),
C=cos(2*pi/W)+i*sin(2*pi/W),
RV_{P} is the previous running value,
W is a selected wavelength, and
N is a selected wavelength number.

4. The system of claim 1, wherein for event values captured at irregular time periods, a new running value RV_{N} for a captured event value v is calculated using:
RV_{N}=KC**T*RV_{P}+(1−K**T)*v,
where:
K=0.5**(1/(W*N)),
C=cos(2*pi/W)+i*sin(2*pi/W),
RV_{P} is the previous running value,
W is a selected wavelength, and
N is a selected wavelength number.

5. The system of claim 1, further comprising a user interface for managing and configuring a set of monitors.

6. The system of claim 1, further comprising a dynamic reconfiguration system for automatically reconfiguring the monitor based on an analysis of the pattern analysis system.

7. The system of claim 1, further comprising a plurality of monitors in which an a running value for each monitor is tracked in an array of the form RV[e, W, N], where e is an entity, W is a selected wavelength, and N is a selected wavelength number.

8. A computer program product stored on a computer readable medium for detecting patterns, comprising:
program code configured for capturing event values from an entity;
program code configured for calculating a new running value based on a previous running value using complex exponential smoothing; and
program code configured for recognizing patterns by analyzing at least one of a strength and a phase the new running value.

9. The program product of claim 8, wherein event values comprise business event data selected from the group consisting of: financial transactions, network transaction, and operational transactions.

10. The program product of claim 8, wherein for event values captured at regular time periods, a new running value RV_{N} for a captured event value v is calculated using:
RV_{N}=KC*RV_{P}+(1−K)*v,
where:
K=0.5**(1/(W*N)),
C=cos(2*pi/W)+i*sin(2*pi/W),
RV_{P} is the previous running value,
W is a selected wavelength, and
N is a selected wavelength number.

11. The program product of claim 8, wherein for event values captured at irregular time periods, a new running value RV_{N} for a captured event value v is calculated using:
RV_{N}=KC**T*RV_{P}+(1−K**T)*v,
where:
K=0.5**(1/(W*N)),
C=cos(2*pi/W)+i*sin(2*pi/W),
RV_{P} is the previous running value,
W is a selected wavelength, and
N is a selected wavelength number.

12. The program product of claim 8, further comprising program code configured for providing a user interface for managing and configuring a set of monitors, wherein each monitor is configured to capture event values from an entity.

13. The program product of claim 12, further comprising a dynamic reconfiguration system for automatically reconfiguring a monitor based on an analysis.

14. The program product of claim 12, wherein a running value for each monitor is tracked in an array of the form RV[e, W, N], where e is an entity, W is a selected wavelength, and N is a selected wavelength number.

15. A method of detecting patterns in business event data, comprising:
selecting a wavelength and wavelength number;
capturing an event value; calculating a new running value based on the event value, wavelength, wavelength number and a previous running value using complex exponential smoothing; and
analyzing the new running value to determine an existence of a pattern.

16. The method of claim 15, wherein the event value comprises business event data selected from the group consisting of: financial transactions, network transaction, and operational transactions.

17. The method of claim 15, wherein for event values captured at regular time periods, a new running value RV_{N} for a captured event value v is calculated using:
RV_{N}=KC*RV_{P}+(1−K)*v,
where:
K=0.5**(1/(W*N)),
C=cos(2*pi/W)+i*sin(2*pi/W),
RV_{P} is the previous running value,
W is a selected wavelength, and
N is a selected wavelength number.

18. The method of claim 15, wherein for event values captured at irregular time periods, a new running value RV_{N} for a captured event value v is calculated using:
RV_{N}=KC**T*RV_{P}+(1−K**T)*v,
where:
K=0.5**(1/(W*N)),
C=cos(2*pi/W)+i*sin(2*pi/W),
RV_{P} is the previous running value,
W is a selected wavelength, and
N is a selected wavelength number.

19. The method of claim 15, further comprising providing a user interface for managing and configuring a set of monitors, wherein each monitor is configured to capture event values from an entity.

20. The method of claim 19, further comprising automatically reconfiguring a monitor based on an analysis of the new running value.

21. A method for deploying pattern detection system, comprising:
providing a computer infrastructure being operable to:
capture event values from an entity;
calculate a new running value based on a previous running value using complex exponential smoothing; and
search for patterns by analyzing at least one of a strength and a phase of the new running value.
